(19) United States
(12) Patent Application Publication
(10) Pub. No.: US 2007/0040854 A1
(43) Pub. Date: Feb. 22, 2007

(54) Method for the representation of 3d image data

(76) Inventors: Marc Lievin, Bonn (DE); Joachim Hey, Bornheim (DE); Erwin Keeve, Bonn (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/568,350

(22) PCT Filed: Jun. 18, 2004
(86) PCT No.: PCT/EP04/06568

§ 371 Date: Oct. 23, 2006

(30) Foreign Application Priority Data
Aug. 15, 2003 (DE) 103 38 145.7

(51) Int. Cl. G09G 5/00

(52) U.S. Cl. 345/669

(57) ABSTRACT

A method for presenting image data 1 that represents a three-dimensional object 7 in a space, wherein projection data which represents a two-dimensional projection 6 of the object 7 are generated by computational superimposing of multiple image planes, wherein the projection 6 is displayed on a monitor for viewing by a user, wherein a sub-area 8 is selected from the projection 6, wherein a detail image 9 is generated inside the sub-area 8 with direct or indirect recourse to the image data 1, wherein the detail image 9 has different informational content than the projection 6, and wherein the detail image 9 is presented on the monitor within the sub-area 8.

The present invention relates to a method for presenting image data, which represents a three-dimensional object in a space, wherein projection data representing a two-dimensional projection of the object is generated from the image data by superimposing multiple image planes, and wherein the projection is displayed on a monitor for viewing by a user.

Modern imaging systems, such as are used particularly in medicine produce image data (3D volume data), which represents the object to be displayed in its three-dimensional state and which must be conditioned and presented for the user or the observer. It is now possible to make subsequent use of preoperative or intraoperative 3D image data of the object to be treated, a jaw for example, in order to make a diagnosis and also to make plans before the surgical procedure. In the medical field, computer tomographs (CT) and magnetic resonance tomographs (MR) are used as 3D imaging devices. Particularly in the dental field, digital volume tomography (DVT), which uses a cone beam, is also used. In this context, a large number (approx. 100) of images are recorded from various angles with an arrangement of an x-ray tube and detector, a C-arch that encircles the patient, and a 3D image data record is created from these x-ray images via known computational methods. The resolution of the resulting 3D image data record is less than 0.5 mm.

The 3D image data is usually displayed on conventional monitors and thus only in two dimensions (2D). From the field of surgery, however, it is known to display three sections through the object lying orthogonal to each other in two dimensions simultaneously. With a pointer instrument, the user is able to specify the respective positions of the sections and/or the depth of the sections. Another display option is the projection of the 3D image data onto a defined plane followed by the 2D display of that plane.

The disadvantage of the known methods is that, for each projection of 3D image data onto a plane, detail information is lost to the extent that averaging is carried out for the individual elements of volume information in the direction of the projection. In the case of the display of a 3D volume by means of the orthogonal sections, management is also relatively cumbersome. An overview display that is necessary for orientation can only appear simultaneously in a separate window via a volume projection or a surface display of the object.

The object of the present invention is provide a method for presenting image data which may be produced simply and inexpensively, and which is both highly practical and extremely reliable. A further object of the invention is to create a system for conducting the method.

These objects are solved by the method having the characterising features of claim 1 and by the system in accordance with claim 16. Special embodiments are described in the respective subordinate claims.

The principal idea of the invention is concerned primarily with displaying the projection, which is of relatively small spatial resolution, as a complete picture. The observer may use this for orientation. Secondly, the user is able to select a section from the projection and display a detailed image of higher or different quality inside it. In this way, the user knows where he is located within the object by referring to the overall image, and receives additional information regarding the location of interest from the detail image. In accordance with the invention, a sub-area is selected from the projection for this purpose, a detail image is generated within the sub-area, and the detail image is then displayed on the monitor.

In an especially preferred embodiment of the invention, the detail image is generated with direct or indirect recourse to the image data from which the projection is generated, wherein this image data has been collected in a first data record. This image data has first been generated by creating a large number of individual images using one of the known methods, particularly with a mobile C-arch or a dental panorama device, and wherein the individual photographs have been processed via a computer program.

The detail image in accordance with the invention differs from the related art in that it has different information content than the projection, and the greater information content may be provided in terms for example of the resolution and/or the perspective and/or the depth information. This detail image is then displayed on the monitor within the frame of the sub-area selected by the user. The user thus sees an image in the image.

The invention thus makes use of the fact that a 3D data record is available, from which the projection display is calculated. Thus, the actual 3D information has always been available, but until now it has not been displayed. In this context, theoretically the calculation of the projection display is simply a weighted superimposition and averaging across multiple planes. By its nature, the specific information for one plane is rendered less precise. In accordance with the invention, the projection display that is familiar to the user is now modified in such a way that he is provided with access to the more detailed 3D information of the data record within the selected sub-area, without requiring the additional display in a separate window on the monitor that was usual before. It is especially advantageous that it may be operated intuitively and interactively and that the projection display remains as easy to understand as before. The area of application of the invention is not limited to the medical field. For example, it might also be used in non-medical fields. An example of such use might be x-ray scanners in airports.

The invention is advantageously realised in such a way that a sub-area in the familiar projection display is marked, and which the user moves to the location for which he would like to see more detailed information with a pointer instrument, such as a mouse, trackball or joystick. For this purpose, the user defines the size and location of the sub-area on the monitor, and in a particular embodiment he may also specify the contour of the border at the himself. In this sub-area, for example, a thinner layer or even just a single cross section plane is presented to the user instead of the full projection. After positioning, the user might also “surf” parallel to the display plane by moving the pointer instrument for the area, in other words, he might advance more or less deeply into the 3D volume depending on the position of the pointer instrument. It is also possible to scroll through the volume lying “hidden” behind the selected area in any other orientation, even transversally for example. As was described previously, in an advantageous embodiment the user thus has interactive access to a wide variety of different image information within the sub-area and, by operating the pointer instrument he is able to “browse” among various options, for example particularly layers that lie parallel to the projection planes.

In an advantageous embodiment, the user may choose from several possible detail images, and the information content of the detail images varies, particularly with regard to the depth, the perspective and/or the type of display represented by the detail image. The detail images may also be formed from “sub-projections”. A sub-projection of such kind refers to a projection that is generated from a collection of a number of image sections, this number nevertheless being smaller than the number of image sections from which the projection serving as the overview is generated. In this context, the number in the area may be between one and the number of all of the available layers minus one. In any case, such a sub-projection is differs from the projections in that it has a greater depth of field, since fewer image planes are superimposed when generating sub-projections. The depth of field is the greatest when exactly one image plane is used to represent one sub-projection. Finally, a specific item of information is prepared in targeted manner from the available image data when generating the sub-projection.

It is arithmetically possible to select any line of vision for the sub-projection, but for reasons of clarity it is advantageous to place the plane of the sub-projections parallel or transversal to the plane of the projection. By continuously “scrolling”, the user is able to explore an object in space and grasp its position. He may also discover structures that lie behind one another and whose spatial arrangement might have remained hidden from him in a projection display. This capability is advantageous in the case of planned dental treatments, since all structures at risk are able to be revealed and their absolute distances measured.

In another advantageous embodiment, the detail image is generated with recourse to the image data, which is collected in a second data record, this image data originating from another image of the object. This image data of the second data record may particularly be recorded with another device or with the same device at another time (e.g. preoperatively or postoperatively), or also with the same device but different device parameters. When superimposing and adjusting various records of image data, image information is advantageously reconciled via known methods. Such methods are known, for example, from “A Survey of Medical Image Registration”, by J. B. Antoine Maintz and Max Viergever, Medical Image Analysis, Vol. 2, pp 1-36, 1998. With the ability to create the detail image from other data stocks as well, the user may also track changes over time or display interesting details with a higher quality corresponding to the other registration mode. In this context, the information derived from the detail images may be increased still further. Superpositions of different data records may also be displayed within the detail image.

It is also advantageous to provide a separate window on the monitor, which may be opened outside of the projection display and in which the various sections through the object may be displayed within the frame of the previously selected sub-area. Thus the user may obtain an overview of the various sections that are available to be displayed before he selects from among these sections. A 3D volume display of the detail or a surface display may appear in the separate window instead of the sections. With regard to such capabilities, the invention is only limited by the stock of image data and the computing power available therefor.

A particularly advantageous field of application of the invention is medicine, in which case the image data represents part of a human or animal body and is recorded with a diagnostic system. Particularly in dentistry, the use of the method is especially advantageous. As was indicated previously, it is also advantageous if the image data is data that has been recorded via a computer tomograph, a magnetic resonance tomograph, a digital volume tomograph, especially with a mobile C-arch.

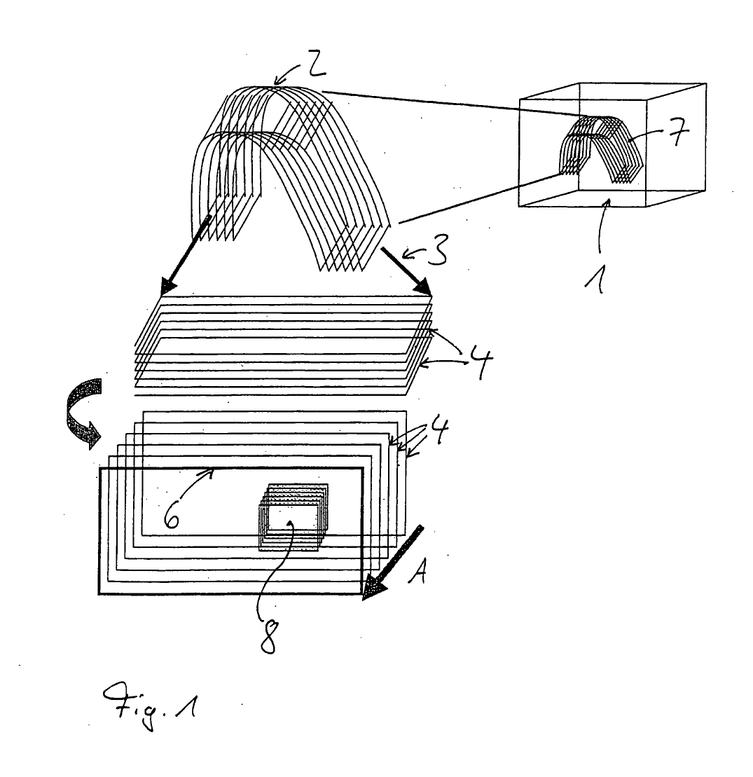

The invention will be described in greater detail in the following with reference to FIGS. 1 to 4. In the drawing:

FIG. 1 shows a diagram of the processing of the image data,

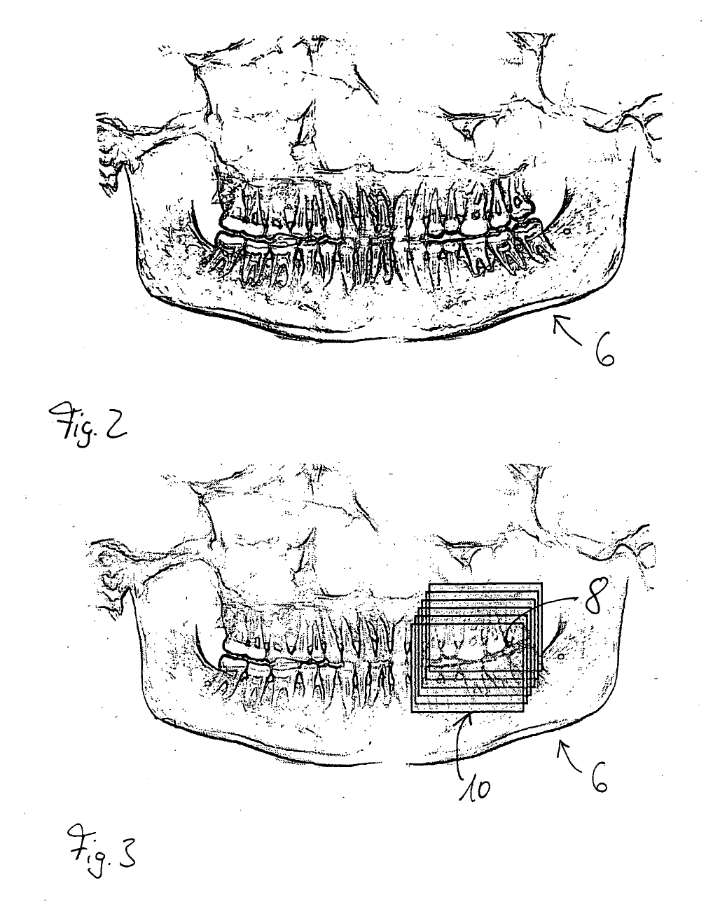

FIG. 2 shows a projection of a jaw,

FIG. 3 shows a projection of the same jaw with a detail view in the sub-area and

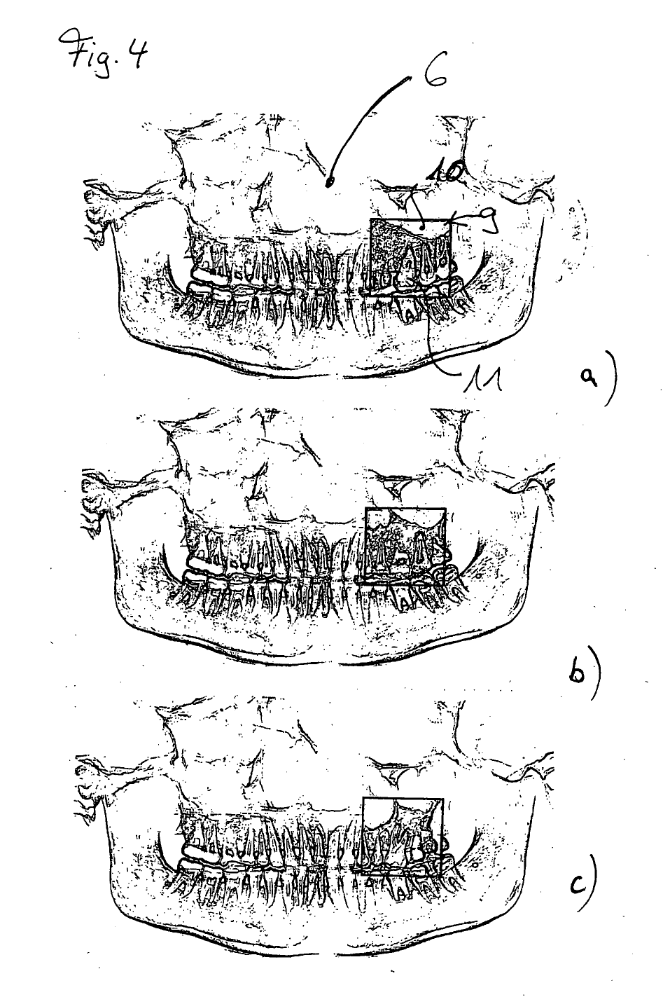

FIG. 4 a-c, show various projections of the jaw, each with a different detail view in the sub-area.

In the figures, the method for presenting image data is shown. First, a record of image data 1 representing the object in space, in this case a human jaw 7, is recorded via a known diagnostic process (CT, MR, DVT or similar). In FIG. 1, the image data 1 is displayed within a storage area shown symbolically as a cuboid. An image data cube including, for example, 2563 pixels, is created as a result of the registration.

For the image creation, parts 2 of the image data 1—in this case essentially the pixels describing the jaw in space—which lie on curved planes along the jaw line—are extracted before a projection 6 (FIG. 2) is finally generated from these parts 2. To create projection 6, in a subsequent method step process 3 the extracted parts 2 are stretched in their three dimensions in such manner that two-dimensional image planes 4 are created one behind the other. These planes 4 are rotated towards the observer 5 and then combined to form projection 6 (FIG. 1, Arrow A), wherein the frame designated by the heavy line represents the projection. However, the information attached to the individual image planes 4 is lost in the addition, since averaging takes place over the entire depth. Finally, projection data representing a two-dimensional projection 6 of the object 7 is generated from the image data by computed superposition of multiple image planes 4, and projection 6 is displayed on a monitor for the user to view. Of course, all the processing steps regarding the image information are performed via a computer.

It is essential for the purposes of the invention that a sub-area 8 is now selected within projection 6. This is done for example via a “mouse” and a cursor that is controlled by the mouse and surrounded by a rectangle on the monitor. Thus the size and/or location on the monitor of area 8 may be defined via a mouse button. Within the selected sub-area 8, the image data 1 is accessed directly or indirectly and a detail image 9 (FIG. 3) is generated, which differs from projection 6 in its image quality and information content. In this case, the individual image planes 4 that are added together in projection 6 are separated again and may be displayed separately. They thus form sub-projections 10 with a higher depth of field.

The stack of sub-projections lying one behind the other within projection 6 is displayed in FIG. 2. With another mouse function, the stack may be “browsed” one layer at a time. Simply by moving the mouse, the treating doctor obtains a feeling for the three-dimensional nature of the teeth and may adjust his treatment to the actual situation. The doctor immediately sees things that were previously hidden. In this way, the risk of the treatment may be significantly reduced.

Expressed another way, a 3D volume data record 1 is stored on the computer while a software program calculates projection 6 along a desired direction. Projection 6 is then displayed on the monitor. The software has access to the entire 3D data record and may display any layer in the sub-area, for example each layer running parallel to the projection plane. The user may then scroll among the layers interactively by moving the pointer instrument, in other words perpendicularly to the displayed plane.

FIG. 4 shows projection 6, which takes up most of the monitor in each case. A detail image 9 appears within each projection, each one showing a different layer within the jaw. The layering of the upper left premolar 11 is shown clearly, of which the two outer roots are shown in FIG. 4c, while the inner root is shown in FIG. 4a. In the projection, these details cannot be viewed separately.

The images of a jaw shown here were recorded with a C-arch according to the prior art. In this context, the method used algorithms that are also known to generate layer images from the individual registrations.

1. A method for presenting image data (1) that represents a three-dimensional object (7) in a space, wherein projection data which represents a two-dimensional projection (6) of the object (7) are generated by computational superimposing of multiple image planes, and wherein the projection (6) is displayed on a monitor for viewing by a user,
characterised in that
a sub-area (8) is selected from the projection (6), wherein a detail image (9) having different information content than the projection (6) is generated inside the sub-area (8), and wherein the detail image (9) is displayed within the sub-area (8) on the monitor.

2. The method in accordance with claim 1,
characterised in that
the detail image is generated in direct or indirect recourse to the image data (1) from which the projection is generated, wherein this image data (1) is collected in a first data record.

3. The method in accordance with claim 1,
characterised in that
the user selects one of several possible detail images (9), which differ in their information content, particularly in the depth and/or the perspective and/or the type of display and/or the depth of information represented by the detail image (9).

4. The method in accordance with claim 1,
characterised in that
a detail image (9) is a sub-projection (10) which differs from the projections (6) in that the depth of field is greater.

5. The method in accordance with claim 4,
characterised in that
the plane (4) of the sub-projections (10) is parallel to the plane of the projection (6).

6. The method in accordance with claim 1,
characterised in that
a separate window is opened on the monitor, in which various sections are displayed by the object (7) within the frame of the selected sub-area (8).

7. The method in accordance with claim 1,
characterised in that
a volume presentation or a surface display takes place in the separate window.

8. he method in accordance with claim 1,
characterised in that
fewer image planes (4) are superimposed when sub-projections (10) with higher depth of field are generated than when projections (6) are generated.

9. The method in accordance with claim 1,
characterised in that
exactly one image plane (4) represents a sub-projection (10).

10. The method in accordance with claim 1,
characterised in that
the user has interactive access to the image information in the sub-area (8) by moving a pointer instrument to scroll among different layers parallel to the projection planes.

11. The method in accordance with claim 1,
characterised in that
the image data represents a part of a human or animal body and is recorded with a diagnostic system.

12. The method in accordance with claim 11,
characterised in that
the image data is recorded with a computer tomograph (CT), a magnetic resonance tomograph (MR), or by digital volume tomography (DVT).

13. The method in accordance with claim 11,
characterised in that
the image data is recorded with a C-arch, which is rotated around the object.

14. The method in accordance with claim 1,
characterised in that
the detail image is generated with direct or indirect recourse to the image data, which is collected in a second data record, wherein this image data originates from another recording of the object.

15. The method in accordance with claim 14
characterised in that
the image data of the second data record is recorded with another device, at another time, or with different device parameters.

16. A system for carrying out the method in accordance with claim 1,
characterised by
a computer with access to the image data, wherein a program that extracts cross-sectional images from the image data and superimposes them on the projection (6) is executed on the computer,
a monitor on which the projection (6) can be displayed,
means that enables the user to define a sub-area (8) within the projection (6), wherein the program includes a function that generates a detail image (9) via indirect or direct recourse to the image data (1), wherein the detail image (9) has different information content than the projection (6) and is displayed on the monitor inside the sub-area (8).

17. The system in accordance with claim 16,
characterised by
means with which the user selects one detail image (9) from among several.

18. Use of the method in accordance with claim 1 to present image data in the field of dentistry.
